(19) United States
(12) Patent Application Publication
(10) Pub. No.: US 2005/0066154 A1
(43) Pub. Date: Mar. 24, 2005

(54) Branch prediction apparatus and method for low power consumption

(76) Inventor: Sung-Woo Chung, Seoul (KR)

Correspondence Address: HARNESS, DICKEY & PIERCE, P.L.C., P.O. BOX 8910, RESTON, VA, 20195, US

(21) Appl. No.: 10/947,278

(22) Filed: Sep. 23, 2004

(30) Foreign Application Priority Data
Sep. 24, 2003 (KR) 2003-66325

(51) Int. Cl. G06F 9/00

(52) U.S. Cl. 712/239

(57) ABSTRACT

A branch prediction apparatus may include a first branch predictor for executing a first branch prediction algorithm and a second branch predictor for executing a second branch prediction algorithm. A choice predictor may generate a control signal for controlling operations of the first branch predictor and the second branch predictor. The choice predictor may also select and output a prediction result of the first branch predictor or the second branch predictor. The first branch predictor and the second branch predictor may respectively execute the prediction algorithms depending on the control signal. The choice predictor may include a shift register for shifting stored branch prediction values of the branch prediction apparatus to the left by one bit. A choice prediction table may be indexed by a value of the shift register to output a predictor selection value. A predictor selecting unit may generate the control signal and a selection signal for selecting an output of one of the first and the second branch predictors. An MUX circuit may output a branch prediction value of the first branch predictor or a branch prediction value of the second branch predictor depending on the selection signal. A computer-readable medium may include instructions causing a computer to perform the functions of selecting one branch predictor from among a plurality of branch predictors by using previous branch prediction results, and executing a branch prediction for a branch instruction by using the selected branch predictor.

### BACKGROUND OF THE INVENTION

This U.S. non-provisional patent application claims priority under 35 U.S.C. § 119 to Korean Patent Application 2003-66325 filed on Sep. 24, 2003, the disclosure of which is incorporated herein in its entirety by reference.

### FIELD OF THE INVENTION

The present invention relates in general to a branch prediction apparatus of a microprocessor, and more particularly, to a branch prediction apparatus and method that may reduce power unnecessarily consumed during a branch prediction operation.

### DESCRIPTION OF THE RELATED ART

A branch instruction statement may be a program instruction. When a predetermined condition included in the branch instruction statement is satisfied, an instruction specified in the branch instruction statement may be executed. Otherwise, another instruction, which may be presented next to the branch instruction statement, may be executed. Such a conditional branch instruction statement may be a representative branch instruction statement. However, various other types of branch instruction statements may be known to those skilled in the art.

To determine an instruction to be subsequently executed, the above branch instruction statement may require a process of fetching (or retrieving) a branch condition included in the branch instruction statement. The fetching process may deteriorate a system performance in a pipelined microprocessor, which may typically need to fetch instructions quickly.

The shortcoming associated with the fetching process may be solved by implementing a branch predictor. A branch predictor may predict a condition retrieval result of the branch instruction statement. A prediction result obtained through the branch predictor may be used to prefetch an instruction to be executed next to the branch instruction statement. The term “prefetch” may refer to retrieving a subsequent instruction without waiting for a branch to be resolved, thereby improving a microprocessor performance.

If a branch prediction turns out to be incorrect, then the previously fetched instructions may be invalid and other instructions may need to be fetched. This refetching of instructions may deteriorate a microprocessor performance. Accordingly, enhancing the accuracy of branch predictor has been pursued. One of the most accurate branch predictors may be a tournament branch predictor.

The tournament branch predictor is well known in this art. FIG. 1 is a block diagram illustrating a conventional, tournament branch predictor.

As shown in FIG. 1, the tournament branch predictor may have three predictors inclusive of a local predictor 100, a global predictor 110, and a choice predictor 120. The branch predictor may also include a global history register 130.

The local predictor 100 may execute a local branch prediction algorithm by using a history of resultant previous branch prediction values for a currently inputted branch instruction. The local predictor 100 may include a Local Prediction Stored Array (“LPSA”) 102 that may include three bits of a prediction bit representing resultant recent prediction values for respective branch instructions, and two bits of a pointer bit representing the number of times used for prediction to output a resultant local prediction value LP_V. The LPSA 102 may be indexed by a Program Counter (“PC”), which may represent an address of a branch instruction to be executed. A Local History Table 104 (“LHT”) may store a history of the resultant prediction values (i.e., whether a branch in the instruction flow of a program is taken or not taken) for the most recent ten branches of the respective branch instructions. A Local Prediction Table 106 (“LPT”) may be indexed by the local history stored in the LHT 104.

After the branch prediction, the LHT 104 and the LPT 106 may update the LPSA 102. Further, the LHT 104 and the LPT 106 may be used for updating the LPSA 102, but they may not be used at the time of the branch prediction.

The global history register 130 may store a history of final branch prediction values PRED_V provided by the branch predictor.

The global predictor 110 may use a Global Prediction Table 112 (“GPT”). The GPT 112 may be indexed by an exclusive OR 140 (XOR) of the PC and the global history inputted from the global history register 130 to execute a global branch algorithm. The global predictor 110 may output the resultant global prediction values GP_V.

The choice predictor 120 may include a Choice Prediction Table 122 (“CPT”). The CPT 122 may be indexed by the global history (from the global history register 130) to output a predictor selection value (“PSEL”). The choice predictor 120 may also include an MUX circuit 124. The choice predictor 120 may select one of the resultant prediction values LP_V and GP_V from the local predictor 100 and the global predictor 110, respectively, and output the selected prediction value as the final branch prediction value PRED_V.

The LPT 106, the GPT 112 and the CPT 122 may be implemented as saturating counters. For updating purposes, an entry of the LPT 106 and the GPT 112 may be incremented by “1” when the branch is predicted to be taken, and decremented by “1” when the branch is predicted to be not taken. An entry of the CPT 122 may be updated depending on a kind (i.e., local or global) of the branch predictor selected for the final branch prediction. That is, the entry may increased or decreased depending on whether the branch prediction value LP_V of the local predictor 100 is selected as the final branch prediction value PRED_V, or the branch prediction value GP_V of the global predictor 110 is selected as the final branch prediction value PRED_V. This updating feature may be arbitrarily defined by a programmer, as is well known in this art.

FIG. 2 is a schematic view of a branch prediction operation that may be performed by the conventional branch predictor of FIG. 1. It will be appreciated that the entry values of each table shown in FIG. 2 may be arbitrarily set for description convenience. In FIG. 2, assume that the inputted PC, representing the address of the branch instruction, may be zero.

In the local predictor 100, a first entry of the LPSA 102 may be indexed by the PC “0”. A Most Significant Bit (“MSB”) value “1” of the prediction bit “110” of the indexed first entry may outputted as the branch prediction value LP_V of the local predictor 100. The MSB of the prediction bit “110” is encircled by a hatched line.

In the global predictor 110, a fourth entry of the GPT 112 may be indexed by an output of the XOR 140 having as inputs ten bits of a global history “0000000011” from the global history register 130 and the PC. An MSB value “0” of the indexed entry “011” may be outputted as the branch prediction value GP_V of the global predictor 110.

In the choice predictor 120, the fourth entry of the CPT 122 may be indexed by the global history “0000000011” from the global history register 130. The MSB value “1” of the indexed entry “100” may be inputted to the MUX circuit 124 as the PSEL for selecting a predictor.

In each predictor, a branch prediction value of “1” may indicate that the branch may be predicted to be taken, and a branch prediction value of “0” may indicate that the branch may be predicted to be not taken. Accordingly, in the scenario depicted in FIG. 2, the predictors 100, 110 may disagree. Namely, the local predictor 100 may predict that the branch may be taken, while the global predictor 110 may predict that the branch may be not taken. Additionally, the branch prediction value LP_V of the local predictor 100 may be selected as the final branch prediction value PRED_V when the PSEL of the CPT 122 is “1”, while the branch prediction value GP_V of the global predictor 110 may be selected as the final branch prediction value PRED_V when the predictor selection value PSEL is “0”. Since the predictor selection value PSEL of the CPT 122 is “1” in FIG. 2, the branch prediction value LP_V of the local predictor 100 being “1” may be outputted as the final branch prediction value PRED_V by the MUX circuit 124. This may indicate that the branch of the branch instruction corresponding to the inputted PC may be predicted to be taken. Accordingly, the microprocessor may prefetch the instruction to be executed in case that the branch may be actually taken, that is, in case a condition of the branch instruction statement may be “true”.

After the branch predictor executes the branch prediction as in FIG. 2, the branch predictor may update respective tables and registers according to the prediction result to be used for a next branch prediction. FIGS. 3A-3E are schematic views of an updating process that may depend on the branch prediction result shown in FIG. 2. The left side of each drawing may depict table values before the updating process, and the right side of each drawing may depict table values after the updating process. Here, an entry value of each table used for the branch prediction may be incremented by “1” when the branch is predicted to be taken (i.e., when the branch prediction result (PRED_V=“1”), and decremented when the branch is predicted to be not taken (i.e., when PRED_V=“0”). However, in the CPT 122, the entry value may be incremented by “1” when the local predictor 100 is selected for the final branch prediction, and the entry value may be decremented by “1” when the global predictor 110 is selected.

FIG. 3A schematically illustrates an updating process that may be performed by the LHT 104 and the LPT 106 included in the local predictor 100 depending on the resultant branch prediction value (PRED_V=“1”) shown in FIG. 2. In FIG. 3A, since the branch is predicted to be taken (i.e., PRED_V=“1”) in FIG. 2, the first entry value “0000000010” of the LHT 104 indexed by the PC may be shifted to the left by one bit, and the resultant current branch prediction value “1” may be inserted into a least significant bit (“LSB”) to form an updated first entry value “0000000101”. Additionally, a third entry value “000” of the LPT 106 indexed by the LHT 104 may be incremented by “1” to form an updated third entry value “001”. In the meantime, and with reference to FIG. 3B, a pointer bit of the first entry of the LPSA 102 may be incremented by “1”, and may be updated with reference to the values of the LHT 104 and the LPT 106 shown in FIG. 3A. The updating process of the LPSA 102 is well known in this art, and therefore a detailed description of the same is omitted.

FIG. 3C schematically illustrates an updating process that may be performed by the global history register 130 depending on the branch prediction result. As shown in FIG. 3C, the value “0000000011” of the global history register 130 may be shifted to the left by one bit, and the resultant branch prediction value “1” may be inserted into the LSB of the register 130 to form an updated value “0000000111”.

FIG. 3D schematically illustrates an updating process that may be performed by the GPT 112 depending on the branch prediction result. The fourth entry value “011” of the GPT 112 used for the current branch prediction may be incremented by “1” to form an updated value “100” since the branch is predicted to be taken.

FIG. 3E schematically illustrates an updating process that may be performed by the CPT 122 depending on the branch prediction result. In the CPT 122, the updated value may be determined according to which predictor is selected. Since the local predictor 100 is selected, the fourth entry value “100” of the CPT 122 used for the branch prediction may be incremented by “1” to form an updated fourth entry value “101”.

Through the above prediction and updating processes, which are conventionally known, the tournament branch predictor may execute an accurate and reliable branch prediction. However, as shown in FIG. 4, in the conventional tournament branch predictor, the three predictors 100, 110, 120 may operate concurrently. That is, the branch predictions may be concurrently executed by respective branch predictors (i.e., the local predictor and the global predictor) and also, the choice prediction may be concurrently executed by the choice predictor 120. Accordingly, the entire branch predictor may cause unnecessary power consumption. For example, as in FIG. 2, when the local predictor 100 is selected as the final branch predictor, the global predictor 110 may consume unnecessary power for non-selected branch prediction. On the contrary, when the global predictor 110 is selected, the local predictor 100 may consume unnecessary power for non-selected branch prediction.

The power consumption by the branch predictor may occupy above 10% of a total power consumption of the microprocessor. Accordingly, it may be desirable to reduce the unnecessary power consumption by the branch predictor to improve the microprocessor performance.

### SUMMARY OF THE INVENTION

Exemplary embodiments of the present invention may reduce power consumption to obviate problems and disadvantages associated with the related art.

Additional advantages and features of exemplary embodiments of the invention will become apparent in view of the description which follows and may be learned from practice of the invention.

In an exemplary embodiment of the present invention, a branch prediction apparatus may include a first branch predictor for executing a first branch prediction algorithm to predict a result of a branch instruction, and a second branch predictor for executing a second branch prediction algorithm to predict a result of the branch instruction. A choice predictor may generate a control signal for controlling operations of the first branch predictor and the second branch predictor. The choice predictor may also select and output a prediction result of the first branch predictor or the second branch predictor. The first branch predictor and the second branch predictor may respectively execute the prediction algorithms depending on the control signal.

In an exemplary embodiment, a branch prediction method may include selecting one branch predictor from among a plurality of branch predictors by using previous branch prediction results, and executing a branch prediction for a branch instruction by using the selected branch predictor.

In another exemplary embodiment, a choice predictor of a branch prediction apparatus may include a shift register for shifting stored branch prediction values of the branch prediction apparatus to the left by one bit. A choice prediction table may be indexed by a value of the shift register to output a predictor selection value. A predictor selecting unit may generate a control signal for controlling operations of a first branch predictor and a second branch predictor depending on the predictor selection value of the choice prediction table. The predictor selecting unit may generate a selection signal for selecting an output of one of the first and the second branch predictors. An MUX circuit may be connected to the first branch predictor and the second branch predictor. The MUX circuit may output a branch prediction value of the first branch predictor or a branch prediction value of the second branch predictor depending on the selection signal.

In an exemplary embodiment, a method of operating a choice predictor of a branch prediction apparatus may include shifting stored branch prediction values of the branch prediction apparatus to the left by one bit. A choice prediction table may be indexed by a value of the shift register to output a predictor selection value. A control signal may be generated for controlling operations of a plurality of branch predictors depending on the predictor selection value.

In another exemplary embodiment, a computer-readable medium may include instructions for enabling a computer to predict whether a branch instruction of a program is taken. The instructions may cause the computer to perform the functions of selecting one branch predictor from among a plurality of branch predictors by using previous branch prediction results. A branch prediction for a branch instruction may be executed by using the selected branch predictor.

It is to be understood that both the foregoing general description and the following detailed description of the present invention are exemplary and explanatory and are not intended as limitations of the claimed invention.

### BRIEF DESCRIPTION OF THE DRAWINGS

The accompanying drawings illustrate exemplary, non-limiting embodiments of the invention and together with the description serve to explain principles of the invention. In the drawings:

FIG. 1 is a block diagram of a conventional branch predictor.

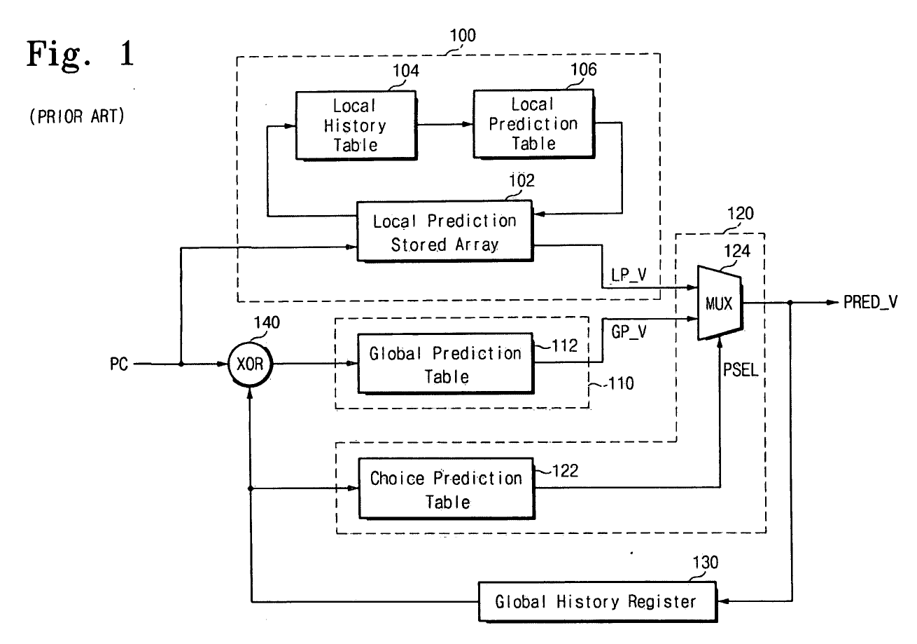

FIG. 2 is a schematic view of a branch prediction operation that may be performed by the conventional branch predictor of FIG. 1.

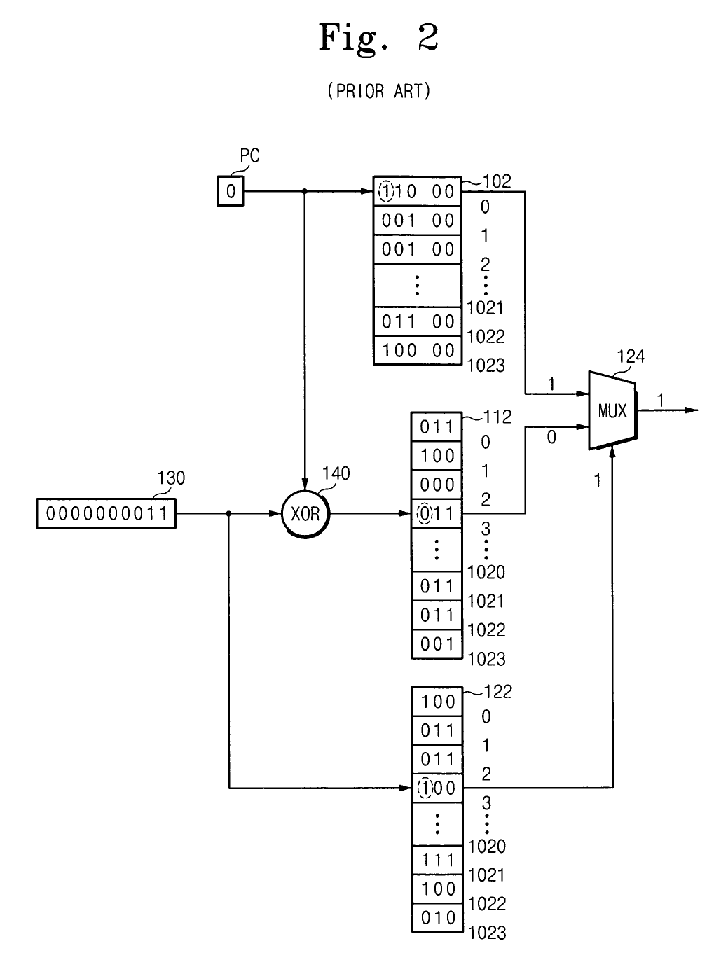

FIGS. 3A to 3E are schematic views of an updating process that may be performed after the branch prediction operation shown in FIG. 2.

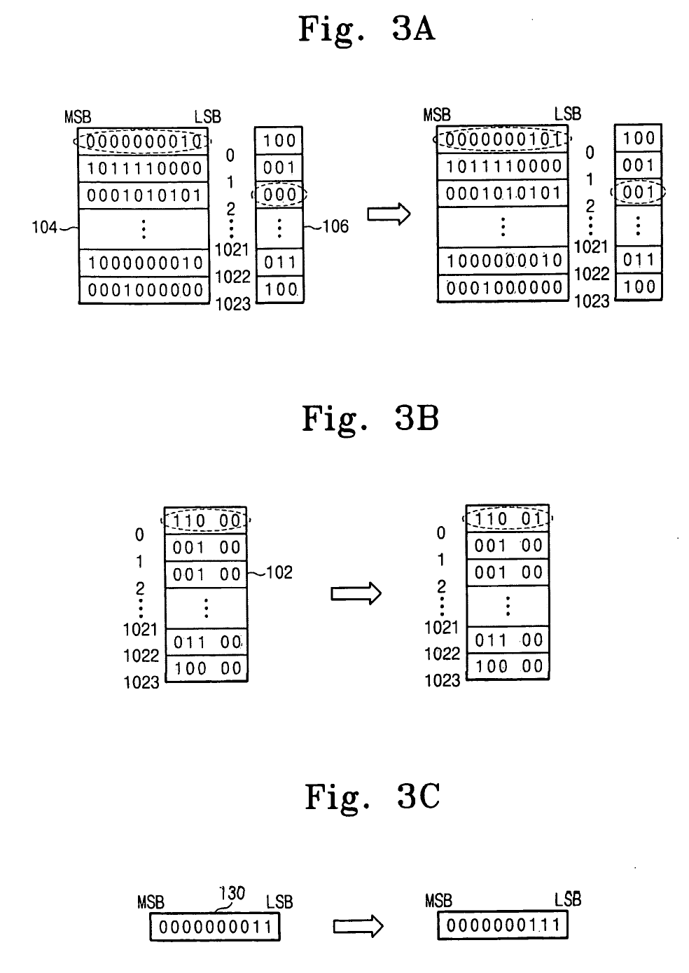

FIG. 4 is a flow chart of the branch prediction process that may be performed by the conventional branch predictor of FIG. 1;

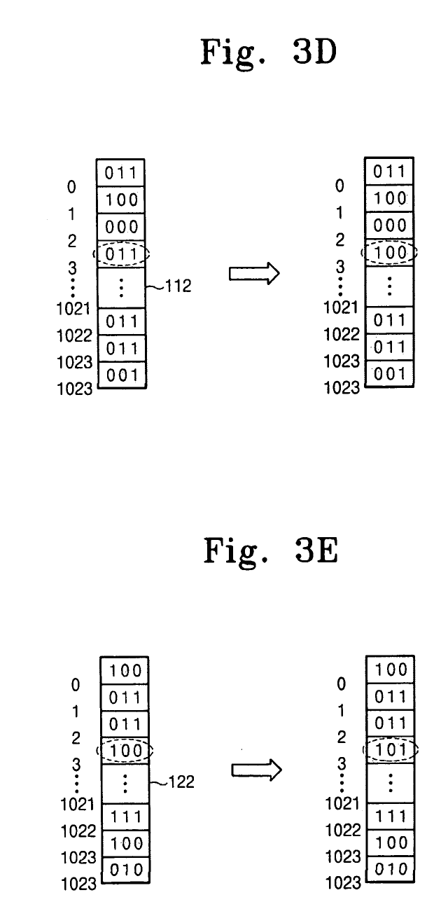

FIG. 5 is a block diagram of a branch prediction apparatus for low power consumption according to an exemplary, non-limiting embodiment of the present invention.

FIG. 6A is a schematic view of a predictor selecting operation that may be performed by a choice predictor according to an exemplary, non-limiting embodiment of the present invention.

FIG. 6B is a schematic view of operations that may be performed by respective branch predictors depending on an operation of the choice predictor.

FIG. 7 is a flow chart of a branch prediction process that may be performed by the branch prediction apparatus according to an exemplary, non-limiting embodiment of the present invention.

FIG. 8 is a schematic view of power consumption depending on a ratio of a branch instruction to a total instruction in each of a conventional branch predictor and a branch prediction apparatus for low power consumption according to an exemplary embodiment of the present invention.

### DETAILED DESCRIPTION OF THE INVENTION

Reference will now be made to exemplary, non-limiting embodiments of the present invention, examples of which are illustrated in the accompanying drawings. However, the present invention is not limited to the details of the illustrated embodiments, which are introduced to provide easy and complete understanding of the scope and spirit of the present invention.

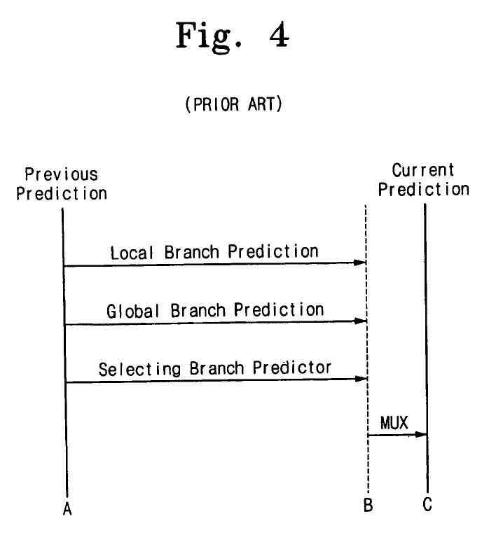

FIG. 5 is a block diagram of a branch prediction apparatus for low power consumption according to an exemplary, non-limiting embodiment of the present invention. Here, the branch prediction apparatus may include a local predictor 500, a global predictor 510, a global history register 530, and a choice predictor 520. The choice predictor 520 may have controlling circuits for controlling respective predictors 500 and 510.

The local predictor 500 may use a local history of previous branch prediction results corresponding to a currently inputted branch instruction to execute a local branch prediction algorithm for predicting a result of a current branch instruction. The local predictor 500 may include a Local Prediction Stored Array (“LPSA”) 502, a Local History Table (“LHT”) 504, a Local Prediction Table (“LPT”) 506, and a control logic 508. The control logic 508 may enable or disable an entire operation of the local predictor 500 depending on a first control signal Ctr10 that may be outputted from the choice predictor 520.

The global history register 530 may be a 10 bit-sized register for storing a global history of previous branch prediction results obtained by the branch prediction apparatus.

The global predictor 510 may use the global history stored in the global history register 530 to execute a global branch prediction algorithm for predicting the result of the current branch instruction. The global predictor 510 may include a Global Prediction Table (“GPT”) 512 for storing recent branch results. The global predictor 510 may also include a control logic 514 that may enable or disable an entire operation of the global predictor 510 depending on a second control signal Ctr11 that may be outputted from the choice predictor 520.

The choice predictor 520 may include a one-bit shift register 522. The shift register 522 may shift the global history of the global history register 530 to the left by one bit. The choice predictor 520 may also include a Choice Prediction Table (“CPT”) 524 for storing a history of a recent predictor choice result. The choice predictor 520 may also include a predictor selecting unit 526. The predictor selecting unit 526 may generate control signals Ctr10 and Ctr11 for controlling the local predictor 500 and the global predictor 510 depending on a prediction result of the CPT 524. The predictor selecting unit 526 may also generate a predictor selection value (“PSEL”) for selecting an output PRED_V of the branch prediction apparatus. The choice predictor 520 may also include an MUX circuit 528.

The choice predictor 520 may use a value from a global history register 530 to perform a predictor selecting process. The predictor selecting process may be performed one cycle earlier than the processes performed by the local predictor 500 and the global predictor 510. For example, assume that a previous value of the global history register 530 may be “0000000001” and that a next selected final branch prediction value may be “1”. Here, the choice predictor 520 may initiate an operation for selecting the predictor one cycle earlier than the operations that may be performed by the local predictor 500 and the global predictor 510 before the next prediction value “1” is selected, that is, before the global history register 530 is updated. An entry of the CPT 524 may be selected by using the next final branch prediction value “1” selected during operation such that a MSB value of the selected entry is outputted.

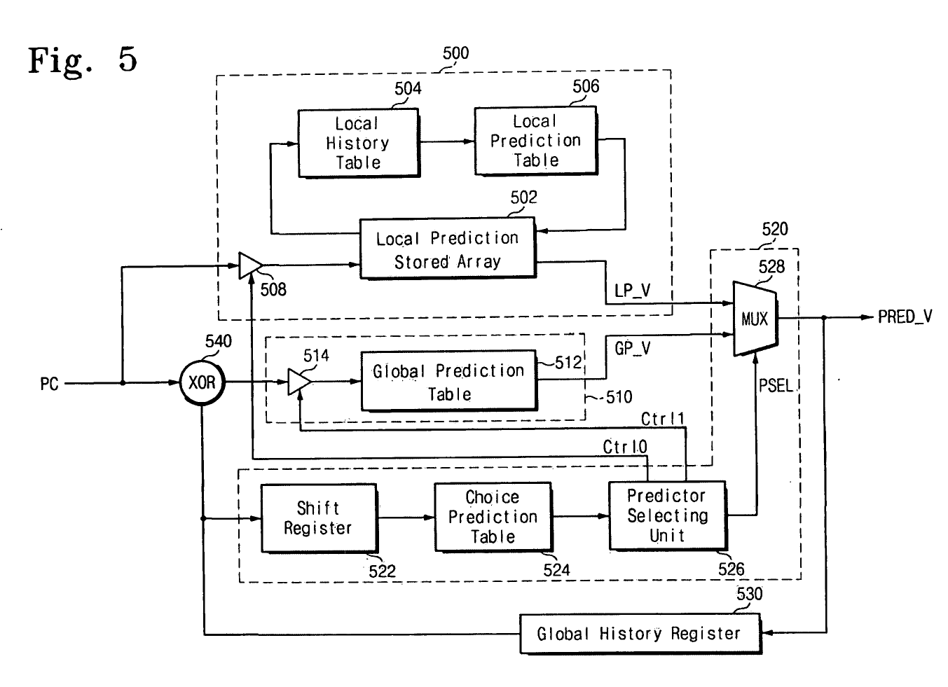

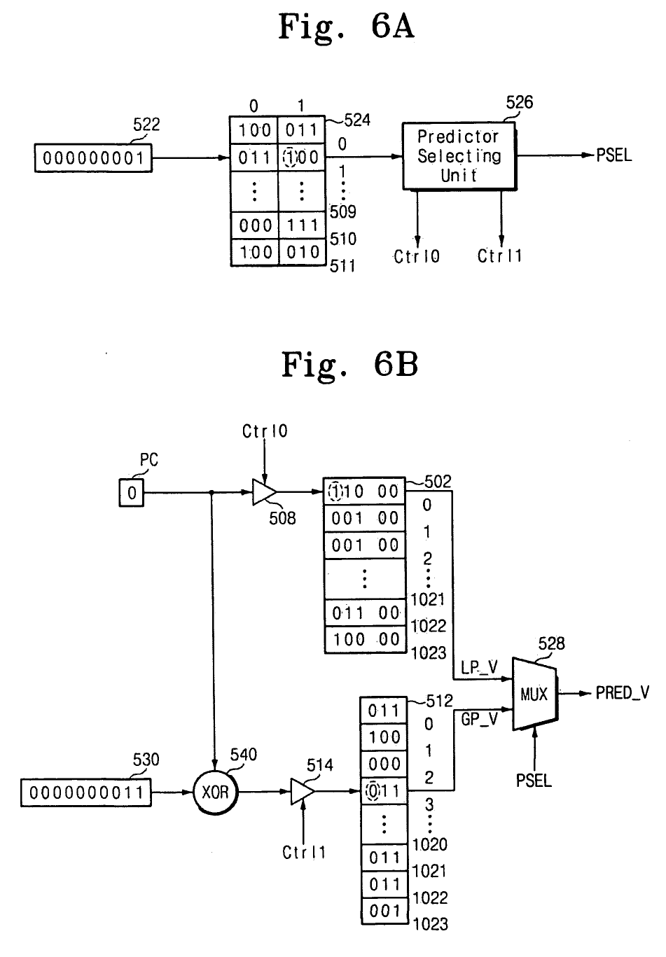

FIG. 6A is a schematic view of a predictor selecting operation that may be performed by the choice predictor 520.

Referring to FIG. 6A, the choice predictor 520 may use the shift register 522 to shift a value “0000000001” of the global history register 530 before updating, to the left by one bit. The choice predictor 520 may select the entry corresponding to the next final branch prediction value “1” subsequently inputted, at a second entry line of the CPT 524 indexed by the shifted 9-bit register value “000000001”, to output the MSB value “1” of the selected entry. Additionally, the predictor selecting unit 526 may use the MSB value “1” outputted from the CPT 524 to generate the control signals Ctr10 and Ctr11 and the PSEL for controlling respective predictors 500 and 510. The first control signal Ctr10 may be inputted to the local predictor 500 to enable or disable an operation of the local predictor 500. The second control signal Ctr11 may be inputted to the global predictor 510 to enable or disable an operation of the global predictor 510.

In this exemplary embodiment, an output LP_V of the local predictor 500 may be selected as an output PRED_V of the entire branch predictor when an output of the CPT 524 is “1”, and an output GP_V of the global predictor 510 may be selected as the output PRED_V of the entire branch predictor when the output of the CPT 524 is “0”. Since the output of the CPT 524 may be “1” in the above case, the output LP_V of the local predictor 500 may be selected as the output PRED_V of the entire branch prediction apparatus. Accordingly, the predictor selecting unit 526 may generate the control signals Ctr10 and Ctr11 such that the local predictor 500 may be enabled and the global predictor 510 may be disabled. The predictor selecting unit 526 may also generate the PSEL for controlling the MUX circuit 528 such that the output LP_V of the local predictor 500 may become the output PRED_V of the entire branch predictor.

Since the CPT 524 shown in FIG. 6A may be indexed by a 9-bit value, it may have 29=512 index lines, and a size of 2⁹×6, for example. This is because the global history register may have a 10-bit value, and the CPT 524 may be indexed by the 9-bit value obtained by shifting the global history register to the left by one bit. The CPT 524 may have twice as much width as and half as much length as the conventional CPT having the same-bit global history register.

FIG. 6B is a schematic view of operations that may be performed by respective predictors depending on the control signals Ctr10 and Ctr11 and the predictor selection signal PSEL from the choice predictor 520 as shown in FIG. 6A.

In FIG. 6B, the predictors 500 and 510 may operate one cycle behind the choice predictor 520 as described above. In other words, after the global history register 530 is updated by the next final branch prediction value “1”, that is, after the register value is updated into “0000000011”, the predictors 500 and 510 may operate depending on the control signals Ctr10 and Ctr11 of the choice predictor 520.

Referring to FIG. 6B, the local predictor 500 may output the MSB value of a LPSA 502 entry indexed by a PC as the branch prediction value LP_V of the local predictor 500. The local predictor 500 may be enabled or disabled by the first control signal Ctr10 from the choice predictor 520. Additionally, in the global predictor 510, an output of the exclusive OR 540 (which may have inputs of the 10-bit value outputted from the global history register 530 and the PC) may be used to index a GPT 512 entry. The MSB value of the indexed GPT 512 entry may be output as the branch prediction value GP_V of the global predictor 510. The global predictor 510 may be enabled or disabled by the second control signal Ctr11 from the choice predictor 520. Since the local predictor 500 may be selected as the predictor of a current branch instruction by the choice predictor 520 in FIG. 6A, the global predictor 510 may be disabled by the second control signal Ctr11, and the local predictor 500 may be enabled by the first control signal Ctr10 to execute a branch prediction operation for the current branch instruction. Therefore, the MSB value “1” of the first entry indexed by the PC may be outputted as the local branch prediction value LP_V, and the local branch prediction value LP_V may be outputted by using the selection signal of the choice predictor 520 as an output of the MUX circuit 528, that is, as the final branch prediction value PRED_V of the entire branch predictor.

After the above branch prediction process is executed, each table and register may be updated. The updating process may be similar to that of the conventional branch predictor and therefore a detailed description of the same is omitted. That is, when the branch is predicted to be taken (PRED_V=“1”), the entry used for the branch prediction may be incremented by “1”, and when the branch is predicted to be not taken (PRED_V=“0”), the entry is decremented by “1”.

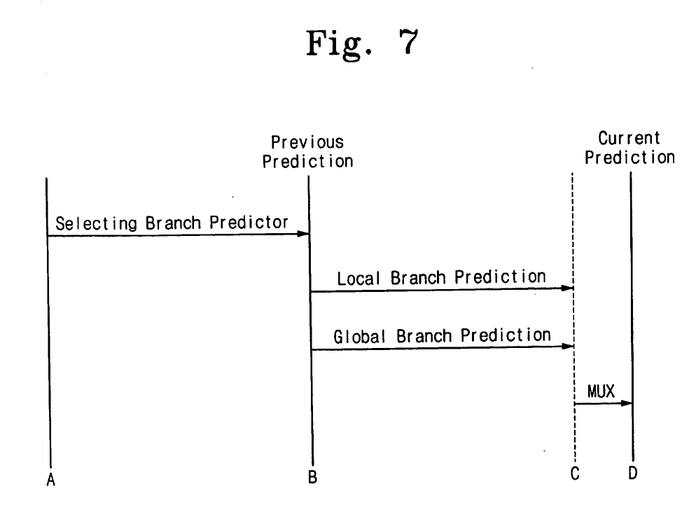

FIG. 7 is a flow chart of a branch prediction process that may be performed by the branch prediction apparatus according to an exemplary embodiment of the present invention.

As shown in FIG. 7, in the exemplary embodiment, the choice predictor 520 may be used to predict and select the predictor to be used for the branch prediction one cycle earlier than operations performed by the local predictor 500 and the global predictor 510. In this way, only the selected predictor may be enabled and a non-selected predictor may be disabled, thereby preventing unnecessary power consumption at the time of the branch prediction.

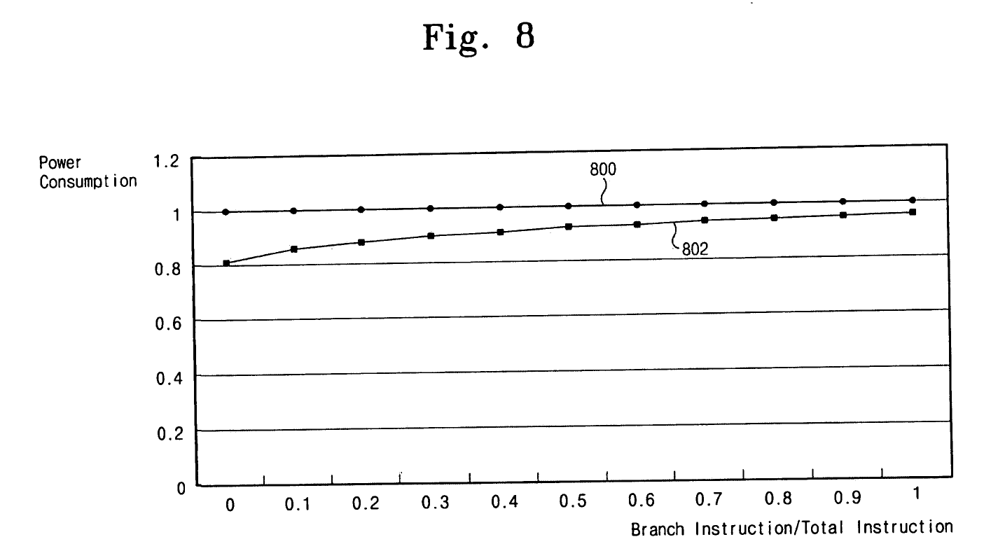

FIG. 8 is a schematic view of power consumption measurements depending on a ratio of a branch instruction to a total instruction in each of the conventional branch predictor and the branch prediction apparatus according to exemplary embodiment of the present invention.

The power consumption was measured using a Samsung memory compiler. The tests were performed under a temperature of 25° C. and an applied voltage of 1.20 volts. Additionally, the measurements were obtained assuming that a prediction percentage of the local predictor may be 75% and a prediction percentage of the global predictor may be 25% on the basis of an average value of the global history.

Referring to FIG. 8, it will be appreciated that the power consumption 802 of the exemplary embodiment may be reduced by about 5 to 19% in comparison with the power consumption 800 by the conventional branch predictor. As shown in FIG. 8, as the ratio of the branch instruction to the total instruction is increased, the power consumption savings of the exemplary embodiment may be slowly reduced. One possible explanation for this might be that as the ratio increases, the power consumption caused by the updating may be a larger percentage of the total power consumption. At the time of updating, the exemplary embodiment may have as similar power consumption as that of the conventional branch predictor.

The ratio of the branch instruction to the total instruction may be from 0 to 0.2 in most applications. Accordingly, the power consumption of the exemplary embodiment may be reduced by about 11 to 19% in comparison with the power consumption of the conventional branch predictor.

As described above, the branch prediction apparatus according to exemplary embodiments of the present invention may reduce the power consumption without experiencing a bad influence on the accuracy of the branch prediction. That is, as shown in the above-described experimental result, the branch prediction apparatus according to exemplary embodiments of the present invention may reduce power consumption by about 11 to 19% in most applications.

The exemplary embodiments of the present invention being thus described, it will be obvious that the same may be varied in many ways. For example, the functionality of the blocks depicted in FIG. 5 may be implemented in hardware and/or software. The hardware/software implementations may include a combination of processor(s) and article(s) of manufacture. The article(s) of manufacture may further include storage media and executable computer program(s). The executable computer program(s) may include the instructions to perform the described operations or functions. The computer executable program(s) may also be provided as part of externally supplied propagated signal(s). Such variations are not to be regarded as departure from the spirit and scope of the exemplary embodiments of the present invention, and all such modifications as would be obvious to one skilled in the art are intended to be included within the scope of the following claims.

1. A branch prediction apparatus comprising:
a first branch predictor for executing a first branch prediction algorithm to predict a result of a branch instruction;
a second branch predictor for executing a second branch prediction algorithm to predict a result of the branch instruction; and
a choice predictor for generating a control signal for controlling operations of the first branch predictor and the second branch predictor, and selecting and outputting a prediction result of the first branch predictor or the second branch predictor,
wherein the first branch predictor and the second branch predictor respectively execute the prediction algorithms depending on the control signal.

2. The branch prediction apparatus of claim 1, wherein the choice predictor operates a predetermined cycle earlier than the first branch predictor and the second branch predictor to select only one of the first branch predictor and the second branch predictor for executing a branch prediction for the branch instruction.

3. The branch prediction apparatus of claim 1, wherein the first branch predictor is a local predictor for executing the branch prediction for the branch instruction by using previous branch prediction results corresponding to the branch instruction.

4. The branch prediction apparatus of claim 1, wherein the first branch predictor comprises:
a local history table for storing a history of branch prediction results for branches of respective branch instructions;
a local prediction table indexed by the history stored in the local history table;
a local prediction stored array indexed by a program counter, and updated by the local history table and the local prediction table; and
a control logic for enabling or disabling an operation of the first branch predictor depending on a first control signal from the choice predictor.

5. The branch prediction apparatus of claim 4, wherein the local history table and the local prediction table are not used at the time of a branch prediction operation.

6. The branch prediction apparatus of claim 1, wherein the second branch predictor is a global branch predictor for executing the branch prediction for the branch instruction by using previous branch prediction results of the branch prediction apparatus.

7. The branch prediction apparatus of claim 1, wherein the second branch predictor comprises:
a global prediction table indexed by a predetermined operation value of previous branch prediction results of the branch prediction apparatus and a program counter, and storing a history of a recent branch prediction result of the branch predictor; and
a control logic for enabling or disabling an operation of the second branch predictor depending on a second control signal from the choice predictor.

8. The branch prediction apparatus of claim 1, wherein the choice predictor comprises:
a shift register for shifting inputted previous branch prediction values of the branch prediction apparatus to the left by one bit;
a choice prediction table indexed by a value of the shift register to output a predictor selection value;
a predictor selecting unit for generating the control signal for controlling operations of the first branch predictor and the second branch predictor depending on the predictor selection value of the choice prediction table, and generating a selection signal for selecting an output of one of the first and the second branch predictors; and
an MUX circuit connected to the first branch predictor and the second branch predictor, for outputting a branch prediction value of the first branch predictor or a branch prediction value of the second branch predictor depending on the selection signal.

9. A branch prediction method comprising:
selecting one branch predictor from among a plurality of branch predictors by using previous branch prediction results; and
executing a branch prediction for a branch instruction by using the selected branch predictor.

10. The branch prediction method of claim 9, further comprising:
disabling another branch predictor that is not selected so that the another branch predictor does not execute a branch prediction for the branch instruction.

11. A branch prediction apparatus configured to perform a branch prediction operation in accordance with the method of claim 9.

12. A choice predictor of a branch prediction apparatus, the choice predictor comprising:
a shift register for shifting stored branch prediction values of the branch prediction apparatus to the left by one bit;
a choice prediction table indexed by a value of the shift register to output a predictor selection value;
a predictor selecting unit for generating a control signal for controlling operations of a first branch predictor and a second branch predictor depending on the predictor selection value of the choice prediction table, and generating a selection signal for selecting an output of one of the first and the second branch predictors; and
an MUX circuit connected to the first branch predictor and the second branch predictor, for outputting a branch prediction value of the first branch predictor or a branch prediction value of the second branch predictor depending on the selection signal.

13. A method of operating a choice predictor of a branch prediction apparatus, the method comprising:
shifting stored branch prediction values of the branch prediction apparatus to the left by one bit;
indexing a choice prediction table by a value of the shift register to output a predictor selection value; and
generating a control signal for controlling operations of a plurality of branch predictors depending on the predictor selection value.

14. A computer-readable medium with instructions for enabling a computer to predict whether a branch instruction of a program is taken, the instructions causing the computer to perform the functions of:
selecting one branch predictor from among a plurality of branch predictors by using previous branch prediction results; and
executing a branch prediction for a branch instruction by using the selected branch predictor.

15. The computer-readable medium of claim 14, wherein the instructions cause the computer to perform the function of disabling another branch predictor that is not selected so that the another branch predictor does not execute a branch prediction for the branch instruction.

16. A choice predictor of a branch prediction apparatus, the choice predictor configured to operate in accordance with the method of claim 13.
